(19) United States
(12) Patent Application Publication
(10) Pub. No.: US 2008/0268335 A1
(43) Pub. Date: Oct. 30, 2008

(54) Combined thin battery structure

(76) Inventors: Yung-Huang Lin, Hsinchu Hsien (TW); Ren-Ting Chuang, Hsinchu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,019

(22) Filed: Jun. 6, 2007

(30) Foreign Application Priority Data
Apr. 25, 2007 (TW) 96206582

(51) Int. Cl. H01M 6/00

(52) U.S. Cl. 429/138

(57) ABSTRACT

A combined thin battery structure comprises a metallic first plate, a plastic frame, a battery module, and a metallic second plate. The first plate has a plurality of jointing slices and first contacting slices formed upwardly from peripheral edges thereof. The frame has a plurality of jointing grooves and fitting grooves formed from peripheral edges thereof. The jointing slices respectively insert into the jointing grooves. The battery module is fixed in the frame. The second plate has a plurality of fitting slices and second contacting slices formed downwardly from peripheral edges thereof. The fitting slices insert into the fitting grooves. Each of the second contacting slices extends to form a flexible arm. Each of the flexible arms has a contacting surface. The contacting surfaces of the flexible arms contact the first contacting slice via surface contact method thus the first plate electrically contacts the second plate to enhance EMI efficiency.

### BACKGROUND OF THE INVENTION

1. Field of the Invention

The present invention relates to a combined thin battery structure, and more particularly to a battery structure for enhancing EMI efficiency.

2. Description of the Prior Art

Please refer to FIG. 1 and FIG. 2. A conventional combined thin battery structure comprises a first plate 1a made of metal materials, a frame 2a made of plastic materials, a battery module 3a, and a second plate 4a made of metal materials. The first plate 1a has a plurality of jointing slices 11a and first contacting slices 12a. Each of the first contacting slices 12a has an opening 121a thereon.

The frame 2a has a plurality of jointing grooves 21a and fitting grooves 22a formed from peripheral edges thereof. The jointing slices 11a are inserted into the jointing grooves 21a.

The battery module 3a includes a battery 31a and a circuit board 32a. The battery 31a is electrically connected with the circuit board 32a and the battery 31a and the circuit board 32a are installed into the frame 2a. The first plate 1a can include a double-sided tape pasted thereon with the battery 32a being fixedly mounted on the first plate 1a by the double-sided tape. The frame 2a has a connector groove 23a thereon. The connector groove 23a corresponds to the circuit board 32a so that the connector groove 23a can be used to electrically connect with connectors of multimedia electronic products.

The second plate 4a downwardly forms a plurality of fitting slices 41a. The fitting slices 41a are respectively inserted into the fitting grooves 22a. The second plate 4a downwardly extends into a plurality of second contacting slices 42a. Each of the second contacting slices 42a obliquely forms a contacting arm 421a and each of the contacting arms 421a has a contact 4211a. The contacting arms 421a are respectively inserted into the open holes 121a of the first contacting slices 12a and the contacts 4211a are respectively contacted with the open holes 121a so that the first plate 1a is electrically conducted with the second plate 4a to achieve EMI efficiency.

However, because the contacting arms 421a of the second plate 4a contact the open holes 121a of the first plate 1a by point contact method, this structure easily causes an unstable conduction between the first plate 1a and the second plate 4a, thereby decreasing EMI efficiency.

The inventor of the present invention recognizes the above shortage should be corrected and special effort has been paid to research this field. The present invention is presented with reasonable design and good effect to resolve the above problems.

### SUMMARY OF THE INVENTION

It is a primary object of the present invention to provide a combined thin battery structure to enhance the EMI efficiency thereof.

For achieving the object stated above, the combined thin battery structure comprises a first plate made of metal materials that has a plurality of jointing slices and first contacting slices formed upwardly from peripheral edges thereof. The combined thin battery structure further comprises a frame made of plastic materials that has a plurality of jointing grooves and fitting grooves formed from peripheral edges thereof. The jointing slices are inserted respectively into the jointing grooves. The combined thin battery structure further comprises a battery module with at least one battery and a circuit board. The battery is electrically connected with the circuit board and disposed on the first plate. The battery and the circuit board are installed into the frame. The combined thin battery structure further comprises a second plate made of metal materials that has a plurality of fitting slices and second contacting slices formed downwardly from peripheral edges thereof. The fitting slices are inserted into the fitting grooves. Each of the second contacting slices is extended to form a flexible arm with a contacting surface. The contacting surfaces of the flexible arms respectively contact the first contacting slices by surface contact method.

The present invention has the advantage that the flexible arms of the second plate contact the first contacting slices of the first plate by surface contact method so that the first plate is electrically conducted and stablely onto the second plate to enhance EMI efficiency.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The above and further advantages of this invention may be better understood by referring to the following description, taken in conjunction with the accompanying drawings, in which:

FIG. 1 is an exploded perspective view of a combined thin battery structure of the prior art;

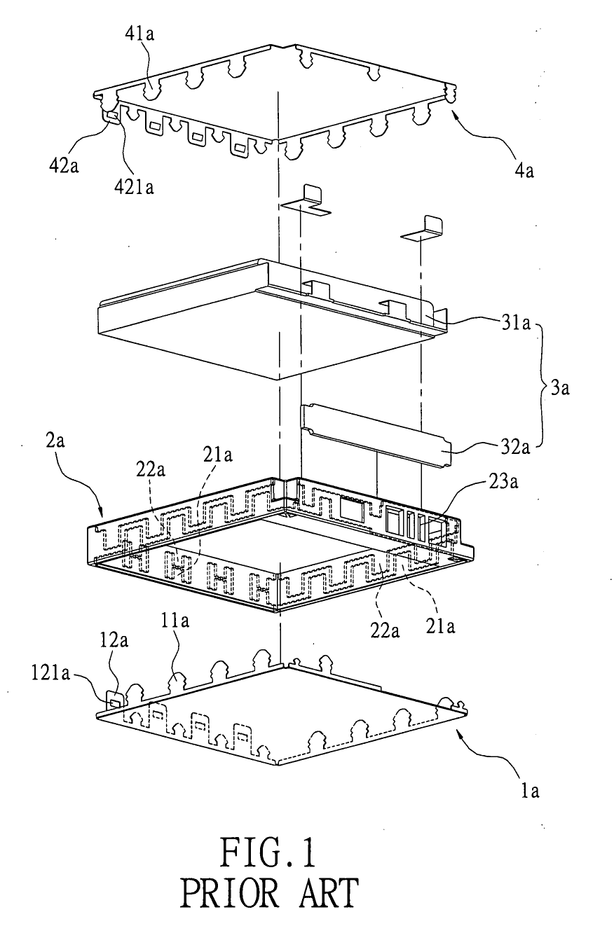

FIG. 2 is a schematic view of a first plate and a second plate of the prior art performing conduction;

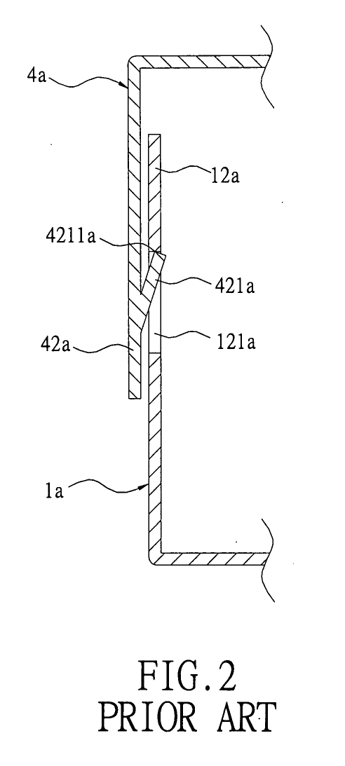

FIG. 3 is an exploded perspective view of a combined thin battery structure according to the present invention;

FIG. 4 is a schematic view a first plate and a second plate according to the present invention performing conduction; and

FIG. 5 is a schematic view the first plate and a circuit board according to the present invention being grounded.

The drawings will be described further in connection with the following Detailed Description of the Invention.

### DETAILED DESCRIPTION OF THE PREFERRED EMBODIMENTS

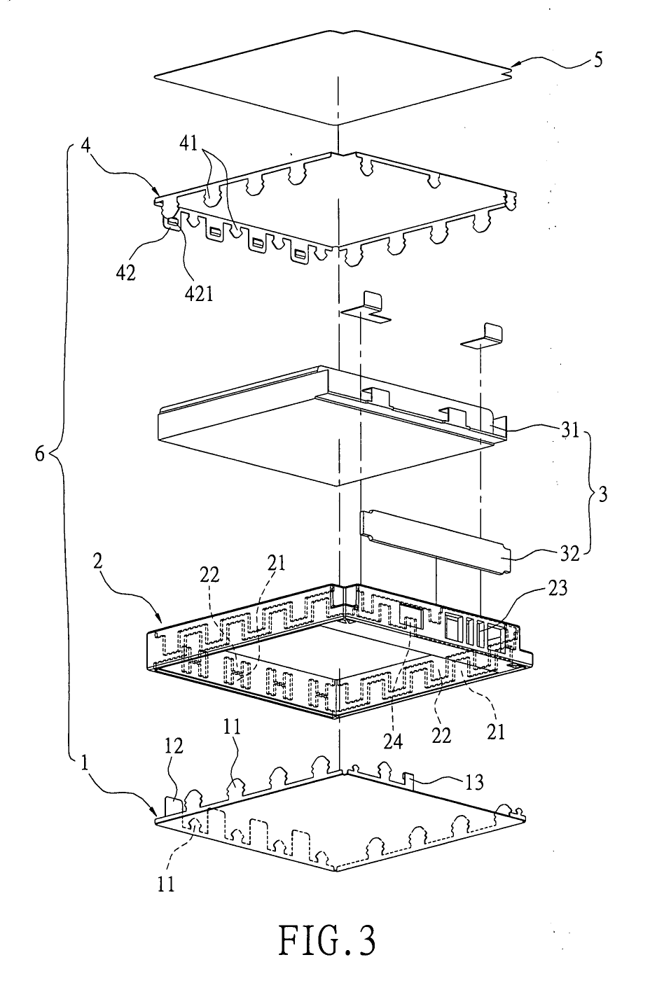

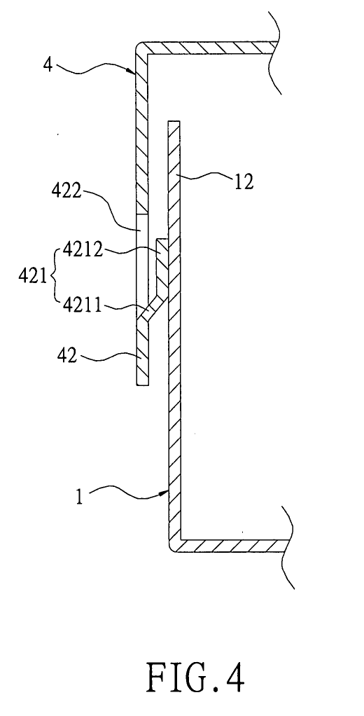

Please refer to FIG. 3 and FIG. 4. The present invention provides a combined thin battery structure that comprises a first plate 1 made of metal materials, a frame 2 made of plastic materials, a battery module 3, and a second plate 4 made of metal materials.

The first plate 1 has a plurality of jointing slices 11 and first contacting slices 12 formed upwardly from peripheral edges thereof. The frame 2 has a plurality of jointing grooves 21 and fitting grooves 22 formed from peripheral edges thereof. The jointing grooves 21 and the fitting grooves 22 are disposed correspondingly and interlacingly on the peripheral edges of the frame 2. The jointing slices 11 are respectively inserted into the jointing grooves 21 by a supersonic method or a heating method so that the first plate 1 is fixed onto a bottom of the frame 2.

The battery module 3 includes a battery 31 and a circuit board 32. The battery 31 is electrically connected with the circuit board 32 and the battery 31. The circuit board 32 is installed into the frame 2. The first plate 1 has a double-sided tape pasted thereon and the battery 32 is fixedly mounted on the first plate 1 via the double-sided tape. The frame 2 has a connector groove 23 thereon. The connector groove 23 corresponds to the circuit board 32. The frame 2 has a grounding groove 24. The grounding groove 24 and the connector groove 23 are disposed on the same side of the frame 2.

The second plate 4 has a plurality of fitting slices 41 and second contacting slices 42 formed downwardly from peripheral edges thereof. The fitting slices 41 and the second contacting slices 42 are interlacingly disposed on the peripheral edges of the second plate 4. The fitting slices 41 are respectively inserted into the fitting grooves 22 so that the second plate 4 is fixed on a top of the frame.

Each of the second contacting slices 42 is pressed to form a flexible arm 421 thereon so that each of the second contacting slices 42 has an opening 422. Each of the flexible arms 421 includes a curved portion 4211 and a contacting surface 4212. Two ends of the curved portion 4211 are respectively connected with the second contacting slice 42 and the contacting surface 4212. The contacting surface 4212 contacts the first contacting slice 12 via surface contact method.

The battery structure further comprises a label 5 and the first plate 1. The frame 2, and the second plate 4 are formed as a casing 6 and the label is stuck on an outside of the casing 6.

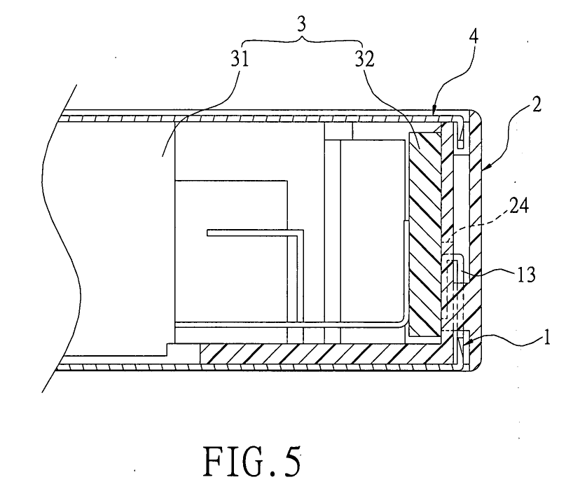

Please refer to FIG. 5. One side of the first plate 1 extends upwardly to a curved arm 13. The curved arm 13 is inserted into the grounding groove 24 and contacts the circuit board 32 so as to ground the first plate 1.

The contacting surfaces 4212 of the flexible arms 421 contact the first contacting slice 12 via surface contact method so that the first plate 1 electrically contacts the second plate 4 to enhance EMI efficiency. Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A combined thin battery structure, comprising:
a first plate made of metal materials and having a plurality of jointing slices, wherein the first contacting slices form upwardly from peripheral edges thereof;
a frame made of plastic materials and having a plurality of jointing grooves and fitting grooves formed from peripheral edges thereof, wherein the jointing slices are respectively inserted into the jointing grooves;
a battery module having at least one battery and a circuit board, wherein the battery electrically connects with the circuit board, and the battery and the circuit board are installed into the frame; and
a second plate made of metal materials and having a plurality of fitting slices and second contacting slices formed downwardly from peripheral edges thereof, wherein the fitting slices are inserted into the fitting grooves, each of the second contacting slices extends to form a flexible arm with a contacting surface, the contacting surfaces of the flexible arms respectively contact the first contacting slices via surface contact method;
whereby, the first plate stably contacts the second plate to enhance EMI efficiency.

2. The combined thin battery structure as claimed in claim 1, wherein the frame has a connector groove thereon, and the connector groove corresponds to the circuit board.

3. The combined thin battery structure as claimed in claim 1, wherein the first plate and the second plate are assembled in the frame via a supersonic method or a heating method.

4. The combined thin battery structure as claimed in claim 1, wherein the jointing grooves and the fitting grooves are correspondingly or interlacingly disposed on the peripheral edges of the frame.

5. The combined thin battery structure as claimed in claim 1, wherein the fitting slices and the second contacting slices are disposed interlacingly on the peripheral edges of the second plate.

6. The combined thin battery structure as claimed in claim 1, wherein the flexible arm further includes a curved portion, and two ends of the curved portion are respectively connected with the second contacting slice and the contacting surface of the flexible arm.

7. The combined thin battery structure as claimed in claim 1, further comprising:
a label, wherein the first plate, the frame, and the second plate forming a casing, and the label is stuck on an outside of the casing.

8. The combined thin battery structure as claimed in claim 1, wherein the frame has a grounding groove, wherein one side of the first plate upwardly extends into a curved arm, and the curved arm is inserted into the grounding groove and contacts the circuit board.
